(19) United States
(12) Patent Application Publication
(10) Pub. No.: US 2005/0195142 A1
(43) Pub. Date: Sep. 8, 2005

(54) Disruptive display device and methods of fabricating same

(75) Inventor: Homer L. Webb, Austin, TX (US)

Correspondence Address: ROSS SPENCER GARSSON;WINSTEAD SECHREST & MINICK P.C., P. O. BOX 50784, DALLAS, TX, 75201, US

(73) Assignee: Solid State Display, Austin, TX (US)

(21) Appl. No.: 11/071,811

(22) Filed: Mar. 3, 2005

Related U.S. Application Data
(60) Provisional application No. 60/551,233, filed on Mar. 8, 2004.

(51) Int. Cl. G09G 3/36

(52) U.S. Cl. 345/87

(57) ABSTRACT

The present invention relates to the field of flat panel displays. And particularly to a flat panel displays composed of printable layers. An embodiment of the present invention comprises a first cross polarizer material layer; an indium tin oxide (ITO) layer printed upon the first polarizer layer with non-contact printing; a polymer dispersed liquid crystal (PLDC) layer printed upon the ITO layer; data electrodes and select electrodes printed upon the PLDC layer; a plurality of thin film transistors (TFT) mechanically place on and electrically coupled to the data electrodes and select electrodes; and a second cross polarizer material layer coupled to a back light source for the flat panel display.

### CROSS REFERENCE TO RELATED APPLICATION

This application is related to the commonly owned copending U.S. Provisional Patent Application Ser. No. 60/551,233, “DISRUPTIVE DISPLAY DEVICE AND METHODS OF FABRICATING SAME,” filed Mar. 8, 2004, and claims the benefit of its earlier filing date under 35 U.S.C. §119(e).

### TECHNICAL FIELD

The present invention relates to the field of flat panel displays. And particularly to a flat panel displays composed of printable layers.

### BACKGROUND INFORMATION

Large area, low cost, flat panels have been desired for a number of years now. Unfortunately the current flat panel technology does not lend itself to the manufacture of a low cost flat panel with low cost manufacturing equipment. Making large flat panel displays results in a premium cost since the yield decreases with size of the display.

There is, therefore, a need for a low cost flat panel display with a corresponding manufacturing process to enable large flat panel displays that are more affordable for the entertainment and computer industry.

### SUMMARY OF THE INVENTION

It is now therefore, the object of the present invention to provide a method of constructing a low cost flat panel display.

Another object of the present design is to eliminate invasive drive electrode material within the cell gap of the display structure.

Another object of the invention is to eliminate active elements from within the cell gap of the display structure.

Another object of the invention is to move the drive electrodes to the outside of the display substrate to facilitate repair.

Another object of this invention make conductivity of electrodes sufficient to drive extremely long electrodes, resulting in very large area display.

Another object of this invention make conductivity of electrodes sufficient to drive large display while maintaining low aspect ratio.

Another object of this invention is to lower the aspect ratio of drive electrodes.

Another object of this invention is to lower the aspect ratio of active elements.

Another objective of this invention is to utilize low threshold electro-optical materials.

Another objective of this invention is to remove evasive effects of control elements within the cell gap of the display structure.

Another object of the invention is to permit low cost high performance displays.

Another objective of this invention is to enable the construction of very large flat panel displays.

Another object of this invention is to enable the construction of very small displays.

Another object of this invention is to enable the construction of very high-resolution displays.

Another object of this invention is to produce a flat panel display architecture with a thin design and light weight that minimizes or eliminates shipping and handling problems associated with current fragile flat panel displays.

Another object of the invention is to permit use of many types of electro-optical material such as, PDLC, Electro-luminescent phosphor, e-ink, e-paper, organic diodes, etc.

Another object of this invention is to eliminate color mask/filters.

Another object of this invention is to reduce the number of drivers.

Another object of this invention is to increase the cell aspect ratio.

Another object of the invention is to propose cell layout.

Another object of this invention is to propose a display manufacturing process.

Another object of this invention is to disclose an active matrix electrical circuit.

Another object of this invention is to disclose an active matrix material.

Another object of this invention is to disclose an active matrix method.

Another object of the invention is to disclose an LED back-lighting method.

Another object of invention is flat panel architecture.

Another object of invention is elimination of TAB bonding.

Another object of invention is to eliminate printed wiring/circuit boards (PWBs/PCBs.)

Another object of invention is to eliminate z-axis bonding of electronics to display.

Another object of invention is to eliminate bottom polarizer.

Another object of invention is to disclose optical system for back-lighting.

Another object of this invention is single substrate.

Another object of invention is printable display architecture.

Another object of invention is mechanical placement of active components.

Another object of invention is printable elements.

Another object of invention is coating methods for display architecture.

Another object of invention is enabling low cost active element manufacturing.

In one embodiment of this invention, electrodes are patterned on the outside of the substrate. Appropriate channels that connect the drive electrodes to the control elements are constructed. The channels may contain and interconnect control elements that connect to the interior cell structure. Control elements may be placed on the outside surface and the channel provides an electrical connection to the interior cell structure. The display may utilize off-the-shelf components or customized components. While the substrates in embodiments of the present invention may be composed of glass, in one embodiment the substrates are composed of polymer. In other embodiments, a composite of glass and polymer are utilized.

In embodiments of the present invention, an electro-optical material is disposed between sandwich substrates containing pixel elements. The display architecture is comprised of a glass or polymer substrate having metal row and column electrodes on the outside of one substrate and ITO cell pattern electrodes on the inside. The other structure contains ITO coated data electrodes on the inside of the structure.

The metal electrodes with increased electrical conductivity lend itself to solving many practical problems for large flat panel displays. Additional objects, advantages and novel features of the invention will become apparent from drawings of the invention and detailed description, which follows.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a profile view of a typical liquid crystal display;

FIG. 2 illustrates a profile view of the disruptive display according to embodiments of the present invention;

FIG. 3 illustrates a typical TFT Display wafer pattern;

FIG. 4 illustrates a transistor pattern with only the transistors shown;

FIG. 5 illustrates a typical transistor pattern with components mounted on the display exterior; and

FIG. 6 illustrates a 10,000 chip placement apparatus for use with embodiments of the present invention.

### DETAILED DESCRIPTION

In the following description numerous specific details are set fourth to provide a thorough understanding of the present invention. However, it will be apparent to those skilled in the art that the present invention may be practiced without specific details. In other instances, well known circuits have been shown in block diagram from in order not to obscure the present invention in unnecessary detail. For the most part, details considering timing considerations and the like have been omitted in as much as details are not necessary to obtain complete understanding of the present invention and are within the skills of persons of ordinary skill in the relevant art.

Refer now to the drawings wherein depicted elements are not necessarily shown to scale and wherein like or similar elements are designated by the same reference numeral through the several views.

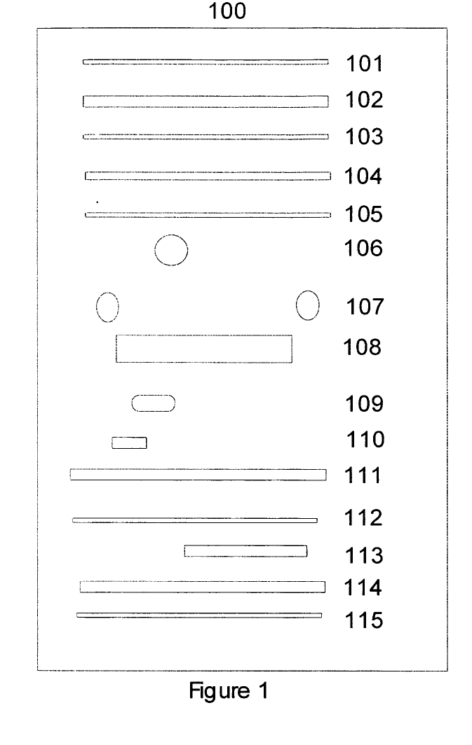

FIG. 1 illustrates a profile view of a typical Cell or pixel of a Liquid Crystal Display (LCD). Cell 100 is typically composed of two crossed outer polarizers 101 and 115. Bonded to a substrate usually glass 102 and 114. One substrate example substrate 1102 normally has a solid layer of transparent conductor 103 typically Indium Tin Oxide (ITO) a color mask 104 and a rubbing layer 105. The bottom substrate has a patterned data electrode 110 and select electrode 111 and a patterned TFT (Thin Film Transistor) transistor 109. A rubbing layer 112 and cell pattern ITO 113 bonded to second substrate 114. Sandwiched between the two substrate 102 and 114 assemblies described above are circular beads or rod shaped spacers 106 and outer seal ring 107. A liquid crystal material (LC) 108 is injected into the space formed between the two substrate assemblies 102 and 114.

The process required to make the TFT 109 transistors bonded on substrate 114 and the assembly process can cost several billion dollars. This capital cost and the extreme precision required to make a TFT display drive up the cost of a typical flat panel display.

The Cell 100 structure in FIG. 1 exhibits several problems. Firstly, the active device TFT 109 requires and expensive semiconductor process. Secondarily, The TFT resides inside the space between the substrates 102 & 114 limiting the cell gap and making a defective TFT 109 device non-repairable. Some display manufactures actually place additional TFT 109 devices on each cell to compensate for a bad TFT device. Cumbersome filling and sealing processes are required. Along with stringent alignment of the color masks 104.

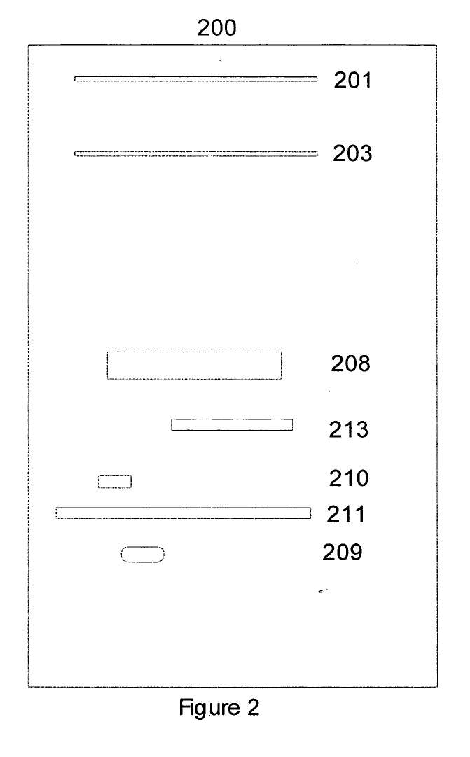

FIG. 2 illustrates the disruptive display structure according to embodiments of the present invention:

Cell 200 comprises a single polarizer 201 upon which is printed a solid layer of ITO 203. Polymer Dispersed Liquid crystal (PDLC) 208 layer is then printed upon the ITO 203 layer. The cell pattern ITO 213 is then printed upon the ITO 203 layer. the data electrode 210 and select 211 electrodes are printed onto the PDLC 208 layer. TFT transistors 209 are mechanically placed onto the electrodes 210, 211 and the patterned ITO 213. A second cross polarizer 215 is located on the back light source.

Since the TFT transistors 209 and electrodes 210 and 213 are located on the outside of the display, the display is repairable. Additionally, there are no filling processes with spacers rubbing layers or color filter alignment. This drastically reduces the processing costs of the display made according to embodiments of the present invention while improving yield.

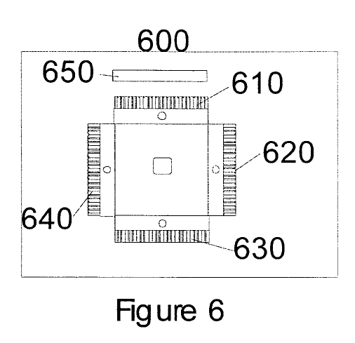

In FIG. 6, 600 illustrates a 10,000 chip placement apparatus 610 is one of four identical chip holding apparatuses 620, 630 and 640. Chip holder 610 is designed to hold 100×100 or 10,000 chips. The chip holder is designed to hold 100 chips A flat panel display device and methods of manufacturing such devices are provided. The technology called “Field Sequential Color (FSC) allows display devices to be made without the use of expensive color filters. These devices do not require sub-pixels generally composed of a Red, Green and Blue sub-pixel. This technology reduces the number of thin film transistors (TFTs) and data drivers by ⅔rds thus simplifying the number of transistors required per display. Embodiments of the low cost display in the present invention utilize the FSC method although the standard sub-pixel method may also be used. A method of manufacturing low cost displays according to an embodiment of the present invention uses PDLC as an optical medium. Other embodiments of the manufacturing process may use optical mediums such an Electro-luminescent, plasma, OLED, PLED, etc.

Embodiments of the present invention use printing techniques to print various elements within the manufacturing process for the low cost flat panel display. The elements that may be printed comprise, the polarizer for the display, the TFTs, the phosphor, the electro-luminescent optical medium. Printing apparatus used to print the elements according to the manufacturing process comprise, a standard letter size printing device (e.g., ink jet printer), a standard plotter printing device, a custom XY table, a modified flat bed printer or a roll-to-roll printing device. The manufacturing process may use pre-coated ITO polarizers and pre-formed PDLC.

Elements of the disruptive display according to embodiments of the present invention may be manufactured in a single printing/coating device or multiple printing/coating devices or in a roll to roll processes. Disruptive displays that are letter sized may use a typical printer that prints letter size documents. Larger displays may use large format Plotters.

In an exemplary process for elements of the present invention an Hewlett Packard (HP®) printer is used that uses a carrier for four ink cartridges wherein, the cartridges contains elected by the designer of the display. For an exemplary process according to the present invention, the following cartridges are used:

Cartridge One is a TFT transistor placement device replacing an ink cartridge.

Cartridge Two contains ITO material.

Cartridge Three contains PDLC material.

Cartridge Four contains conductive ink.

The software to drive the printer remains may remain unmodified. In one embodiment of the manufacturing process, a graphics program such as Corel Draw is utilized to create the display using the modified printer according to the following steps:

1. Cut the polarizer 8.5×11 inch representing letter size paper.

2. Generate a Drawing One that patterns the solid layer of ITO using Cartridge Two.

3. Generate a Drawing Two that patterns the solid PDLC using Cartridge Three.

4. Generate a Drawing Three that patterns the cell pattern ITO using Cartridge Two.

5. Generate a Drawing Four that patterns the Data and select electrodes using Cartridge Four.

6. Generate a Drawing Five that patterns the TFT contacts and Place The TFT from cartage Four and One.

Next the parts are patterned using the modified printer.

Step 1 Place polarizer in Printer.

Step 2 Print ITO.

Step 3 Print PDLC and Cure.

Step 4 Print Cell pattern ITO.

Step 5 Print conductive data electrodes and select electrodes.

Step 6 Print conductive pads for TFT, Print TFT.

At this point in the manufacturing process, the display needs to have the driver circuits attached and the back light assembly to complete the display. Note it is expected that the driver electrodes and IC pads are printed in Step 5 above.

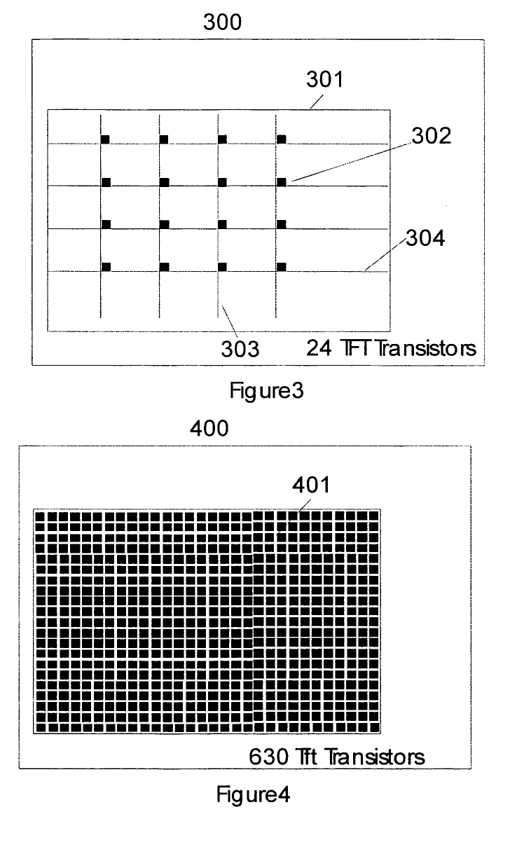

Embodiments of the present invention, one improvement in the manufacturing of flat panel displays is the application of active elements (e.g., TFTs) as used in the TFT display shown in FIG. 3. Typical a wafer 301 is composed of data electrodes 304 and select electrodes 303 with TFT transistors 302 placed at the intersection of the electrodes 303, 304. In this case, most of the area of wafer 301 is empty. In embodiments of the present invention, the wafer 301 may be utilized as a substrate to make printable TFT transistors as shown in FIG. 4. In this embodiment, the entire wafer 401 may be utilized and electrodes are not required. In FIG. 3, wafer 301 contains 24 transistors compared to 630 transistors contained in wafer 401 illustrated in FIG. 4.

Using embodiments of the present invention opens a full range of opportunities to utilize emerging as well as established technologies. The display proposed in the present invention utilizes off-the-shelf silicon Field Effect transistor (FETs) designs such as Phillips® the BFR 30 FETs fabricated on a 4-inch silicon wafers. A special placement device, shown in FIG. 6, is constructed to place the BFR 30 transistors down one-at-a-time. Other devices are shown that permit printing up to 10 thousand of transistors. However, embodiments of the present invention enables the use of emerging technologies such a TFT on plastic. Some suppliers such as Flex IC's® are making a 6-inch EXtended Graphics Array (XGA) wafer containing 4 displays composed 1024×768. This substrate will market at approximately $30.00. XGA is a screen resolution of 1,024×768 pixels. The term stems from IBM's® XGA display standard introduced in 1990, which extended VGA to 132-column text and interlaced 1,024×768×256 resolution. XGA-2 later added non-interlaced 1,024×768×64 K. If such a wafer is used for making printable transistors only, then the 6-inch wafer could contain 10 to 50 times more transistors allowing a single wafer to make 20 displays. Therefore, the cost of all the TFT's for a printed display would be only $1.50 dollars. A laser could be used to dice up the wafer to extract the TFT transistors need for a single display. Additionally, since the substrate does not have to be a display component, substrates such as high temperature plastics, metals and glasses could be utilized to fabricate higher performing transistors.

Embodiments of the present invention may use multiple ways to fabricate printable transistors:

1. Single transistor at a time. This method would be the lowest cost to implement. But one must consider the amount of time required to make a display. In the case of an XGA 1024×768=786,342 transistors. For a FSC display and three times that for a RGB pixel display. If one could print one transistor a second then it would take 786,342 seconds or 218.45 hours or about 9.1 days to place the transistors. A typical ink jet can print 10 or more sheets per minute. Considering a 60 inch display is 12 square ft. or 21 sheets 8×10 inches. Then a display can be printed in 2.1 minutes.

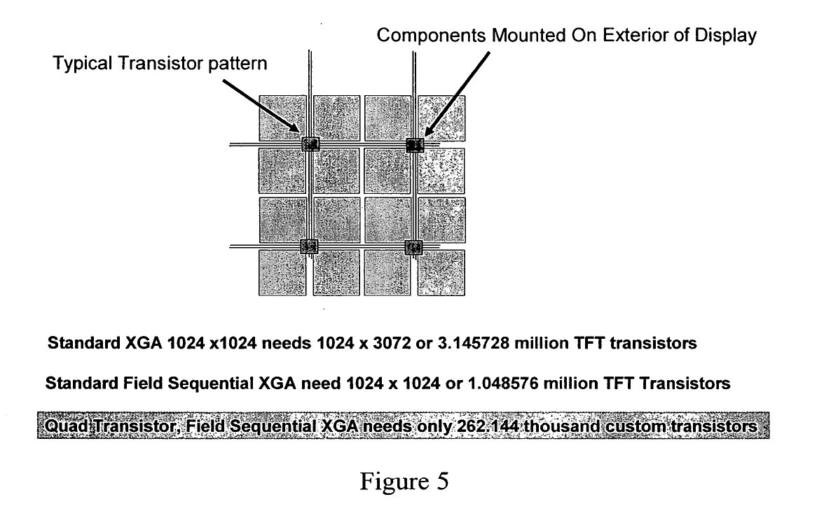

2. Two multiple transistors. For example, four transistors at a time placed in each quadrant as shown in FIG. 5. This would reduce the time and number of placement by four reducing manufacturing time from 9 days to 2.5 days.

3. Many multiple. For example, the placement device illustrated in FIG. 6 places 10,000 transistors at a time. Reducing the time to make a display to 78.64 seconds or only 1.3 minutes. Thus, the disruptive display, fabricated according to embodiments of the present invention, reduces the time to make a display from the current time of 5-7 days or more to make a standard flat panel display.

The present invention and its advantages have been described in detail, it should be understood that various changes, substitutions and alterations can be made herein without departing from the spirit and scope of the invention as defined by the appended claims.

1. A flat panel display comprising:
a) a first cross polarizer material layer;
b) an indium tin oxide (ITO) layer printed upon the first polarizer layer with non-contact printing;
c) a polymer dispersed liquid crystal (PLDC) layer printed upon the ITO layer;
d) data electrodes and select electrodes printed upon the PLDC layer;
e) a plurality of thin film transistors (TFT) mechanically place on and electrically coupled to the data electrodes and select electrodes; and
f) a second cross polarizer material layer coupled to a back light source for the flat panel display.

2. A method for fabricating a flat panel display comprising the steps of:
a) modifying an inkjet printer having at least four ink cartridges such that a first cartridge is a TFT transistor placement device replacing an ink cartridge, a second cartridge contains ITO material, a third cartridge contains PDLC material, and a fourth cartridge contains conductive ink; and
b) sequentially printing selected elements required for the flat panel display on a cross polarizer material layer.

3. The method of claim 2, wherein software to drive the ink jet printer remains may remain unmodified.

4. The method of claim 3, wherein a standard graphics program is used to create the selected elements required for the flat panel display.

5. The method of claim 4 further comprising the steps of:
a) partitioning the first cross polarizer into letter size format;
b) generating a first drawing as a pattern for the solid layer of ITO;
c) generating a second drawing that patterns the solid PDLC;
d) generating a third drawing that patterns the cell pattern ITO;
e) generating a fourth drawing that patterns the Data and select electrodes; and
f) generating a fifth drawing that patterns the TFT contacts and Place.

6. The method of claim 5, further comprising the steps of:
a) placing the first cross polarizer material layer in the modified;
b) printing a solid ITO layer on the first cross polarizer using cartridge two;
c) printing the PDLC layer on the ITO layer using cartridge three and curing the PDLC layer;
d) printing a cell pattern ITO using cartridge two;
e) printing the conductive data electrodes and select electrodes using cartridge four; and
f) printing conductive pads for the TFTs.

7. The method of claim 6, further comprising the step of attaching driver circuits and a back light assembly.
